(19) United States
(12) Patent Application Publication
(10) Pub. No.: US 2010/0253649 A1
(43) Pub. Date: Oct. 7, 2010

(54) OPTICAL TOUCH MODULE

(75) Inventor: Hui-Hsuan Chen, Hsin-Chu (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: PIXART IMAGING INC., Hsin-Chu (TW)

(21) Appl. No.: 12/612,277

(22) Filed: Nov. 4, 2009

(30) Foreign Application Priority Data
Apr. 1, 2009 (TW) 098205222

(51) Int. Cl. G06F 3/042

(52) U.S. Cl. 345/175

(57) ABSTRACT

An optical touch module is used for providing a touch space, and includes a substrate, a sensor, and a light guiding element. The substrate is located below the touch space, and the sensor is disposed on a surface of the substrate facing the touch space. The light guiding element is located at a corner of the touch space. The light guiding element includes a light incident surface facing the touch space, and a light exit surface facing the sensor. Therefore, by fabricating the sensor on the substrate below the touch space, the thickness of the optical touch module and the cost of the substrate can be reduced.

### CROSS-REFERENCE TO RELATED APPLICATIONS

This non-provisional application claims priority under 35 U.S.C. §119(a) on Patent Application No(s). 098205222 filed in Taiwan, R.O.C. on Apr. 1, 2009, the entire contents of which are hereby incorporated by reference.

### BACKGROUND OF THE INVENTION

1. Field of Invention

The present invention relates to a touch module, and more particularly to an optical touch module.

2. Related Art

In recent years, a touch screen (that is, a touch panel) that can be directly controlled by an object or a finger through a touch operation has replaced conventional mechanical operations of buttons. When a user touches a picture on the screen, a tactile feedback system on the screen may drive various connecting devices according to a preset program, and present a vivid video and audio effect through the screen.

Common touch screens may be classified into resistive touch screens, capacitive touch screens, acoustic wave touch screens, optical touch screens, and the like. An optical touch screen is based on the reception and interception of a light source, that is, when the light is intercepted, the position of a receiver that fails to receive a signal can be known, thereby determining an accurate position thereof. Referring to FIGS. 1 and 2, an optical touch screen includes a light emitting device 1, a reflector, an optical receiver 3, and a lens 5 disposed on a liquid crystal display (LCD) 7. The light emitting device 1 and the optical receiver 3 are disposed at the top right corner on a glass panel of the LCD 7, and the reflector 2 is disposed on a left side and a lower side on the glass panel of the LCD 7. The light emitting device 1 emits light and the reflector 2 at the distant end reflects the light, so as to form a touch space 4. When a finger or an object contacts the touch space 4 and intercepts the light, the optical receiver 3 may collect a relative position of the finger or the object on the touch space 4 through the lens 5.

A conventional optical touch screen may be applied in an LCD, an electronic whiteboard and the like to provide a touch function. However, since elements such as the optical receiver and the lens of the optical touch screen are required to be disposed on the LCD or the electronic whiteboard, the overall thickness of the optical touch screen cannot be reduced.

### SUMMARY OF THE INVENTION

Accordingly, the present invention is an optical touch module, so as to avoid disposing an optical receiver, a lens and the like on an LCD or an electronic whiteboard, thereby reducing the overall thickness of the optical touch screen.

The optical touch module of the present invention is used for providing a touch space. The optical touch module comprises a substrate, at least one sensor, and at least one light guiding element. The substrate is located below the touch space. The at least one sensor is located on a surface of the substrate facing the touch space. The at least one light guiding element is located at a corner of the touch space. Each light guiding element comprises a light incident surface facing the touch space, and a light exit surface facing one of the at least one sensor.

In the optical touch module of the present invention, the light is distributed by the light emitting surface to the touch space, and then guided by the light guiding element such as a prism or a waveguide element to the sensor on a surface of the substrate such as an ITO glass in the LCD. When the sensor detects that a portion of the light is intercepted, the sensor determines a relative position of an object to be detected on the touch space. Herein, since the sensor is disposed on the same substrate as the LCD, the cost required for disposing the sensor on an additional substrate can be saved. Moreover, since elements such as the sensor and the lens are disposed below the touch space, the thickness of the optical touch screen can be reduced.

For purposes of summarizing, some aspects, advantages and features of some embodiments of the invention have been described in this summary. Not necessarily all of (or any of) these summarized aspects, advantages or features will be embodied in any particular embodiment of the invention. Some of these summarized aspects, advantages and features and other aspects, advantages and features may become more fully apparent from the following detailed description and the appended claims.

### BRIEF DESCRIPTION OF THE DRAWINGS

The present invention will become more fully understood from the detailed description given herein below for illustration only, and thus are not limitative of the present invention, and wherein:

FIG. 1 is a top view of a conventional optical touch module;

FIG. 2 is a side view of the conventional optical touch module;

FIG. 3 is a top view of an optical touch module according to a first embodiment of the present invention;

FIG. 4 is a side view of the optical touch module according to the first embodiment of the present invention;

FIG. 5 is a top view of an optical touch module according to a second embodiment of the present invention; and

FIG. 6 is a side view of the optical touch module according to the second embodiment of the present invention.

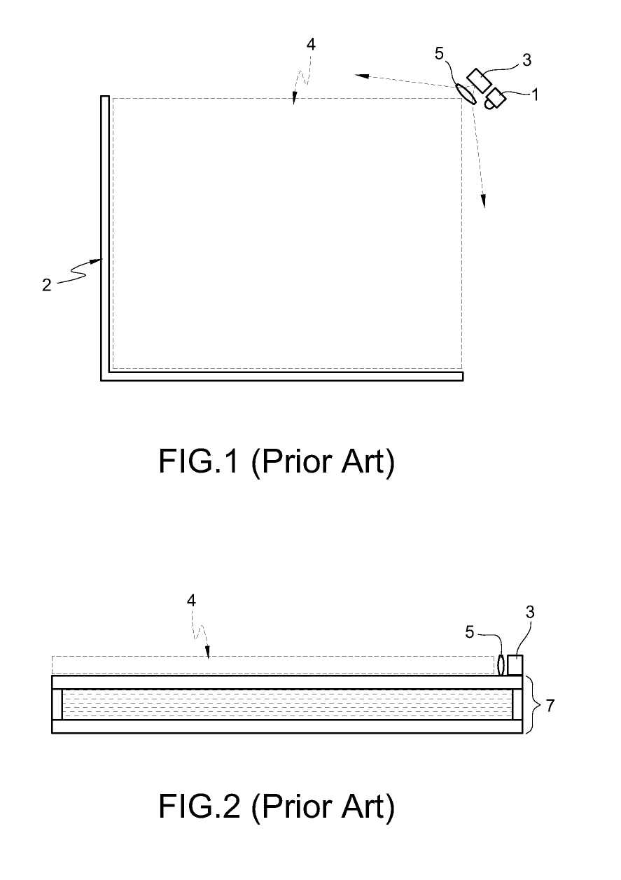

### DETAILED DESCRIPTION OF THE INVENTION

Certain embodiments of the invention relate generally to electronic dispersion compensation systems and methods. However, the disclosed embodiments of systems and methods may be used in other contexts unrelated to electronic dispersion compensation.

An optical touch module can be used as a touch screen of an electronic device (such as a screen of a display or a base plate of an electronic whiteboard) to serve as an input interface of the electronic device.

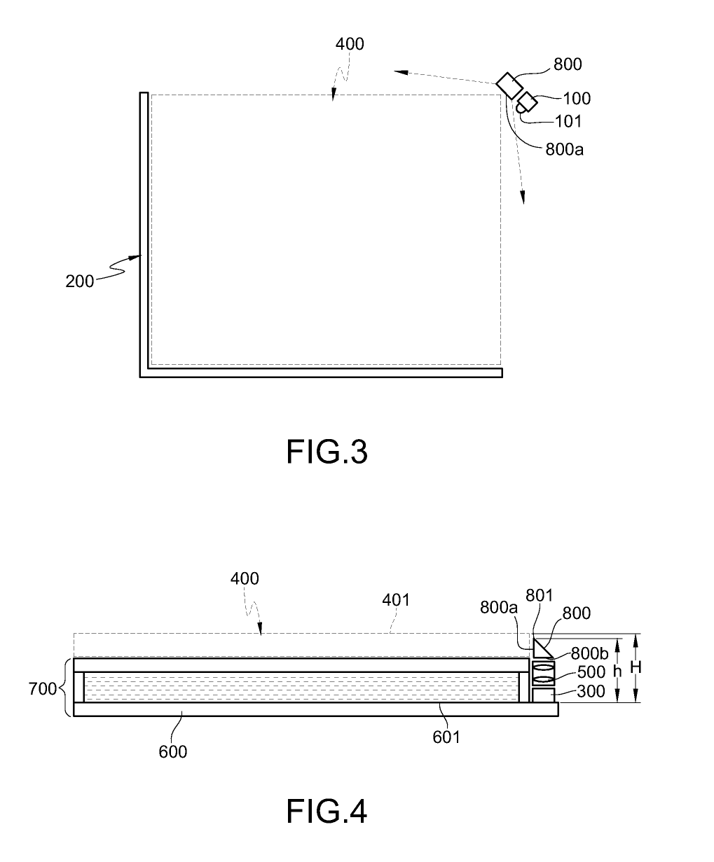

FIG. 3 is a top view of an optical touch module according to a first embodiment of the present invention. FIG. 4 is a side view of the optical touch module according to the first embodiment of the present invention.

Referring to FIGS. 3 and 4, in this embodiment, the optical touch module is used for providing a touch space 400.

The optical touch module comprises a substrate 600, at least one sensor 300, and at least one light guiding element 800.

The number of the sensor 300 and the number of the light guiding element 800 may also be more than one. For the convenience of illustration, in this embodiment, the number of the sensor 300 is one, and the number of the light guiding element 800 is one, but the present invention is not limited thereto.

The substrate 600 is located below the touch space 400, and has a conductive circuit (not shown).

The optical touch module may further comprise an LCD 700, that is, the LCD 700 is disposed below the touch space 400. The substrate 600 may be an ITO glass in the LCD 700. The substrate 600 may also be a PCB, and the LCD is directly connected to the PCB.

The sensor 300 is located on a surface of the substrate 600 facing the touch space 400. The sensor 300 is electrically connected to the conductive circuit.

The light guiding element 800 is located at a corner of the touch space 400. The light guiding element 800 may comprise a light incident surface 800a facing the touch space 400, and a light exit surface 800b facing the sensor 300.

The optical touch module further comprises at least one light emitting element 100, at least one reflector 200, and at least one lens 500.

The number of the light emitting element 100, the number of the reflector 200, and the number of the lens 500 may be more than one. For the convenience of illustration, in this embodiment, the number of the light emitting element 100 is one, the number of the reflector 200 is one, and the number of the lens 500 is two, but the present invention is not limited thereto.

The light emitting element 100 is located at a corner of the touch space 400. The light emitting element 100 is located at the same corner of the touch space 400 as the light guiding element 800. The light emitting element 100 may also be located at a corner of the touch space 400 different from the light guiding element 800.

The light emitting element 100 may comprise a light emitting surface 101. Since the light emitting element 100 is located at a corner of the touch space 400, it indicates that the light emitting surface 101 is located at a corner of the touch space 400. The light emitting surface 101 is used for providing light substantially in parallel with an upper edge 401 of the touch space 400.

The light guiding element 800 is correspondingly disposed on the sensor 300, such that the light incident surface 800a of the light guiding element 800 receives the light and guides the light to the corresponding sensor 300 via the light exit surface 800b.

The reflector 200 is located at periphery of the touch space 400. In this embodiment, the reflector 200 is located at two side edges of a corner of the touch space 400 opposite to the light emitting element 100. The reflector 200 may also be located at each side edge of the touch space 400.

Each lens 500 is located between the light exit surface 800b of one of the at least one light guiding element 800 and the sensor 300 corresponding to the light exit surface 800b of the one of the at least one light guiding element 800.

In this embodiment, illustration is given by taking two lenses 500 as an example, and the two lenses 500 are located between the light exit surface 800b of the light guiding element 800 and the sensor 300 corresponding to the light guiding element 800. One lens 500 is adjacent to the light exit surface 800b, and the other lens 500 is adjacent to the sensor 300. The two lenses 500 are adjacent to each other and have the same optical axis. A normal line perpendicular to the center of the light exit surface 800b may be the optical axis of the two lenses 500.

The light emitting element 100 may generate light and emit the light to the touch space 400. The light emitted by the light emitting element 100 is infrared light, visible light, or the like.

The reflector 200 reflects the light emitted by the light emitting element 100.

The light guiding element 800 receives the light reflected by the reflector 200 through the light incident surface 800a, transmits the light to the light exit surface 800b, and emits the light to the sensor 300 on the surface of the substrate 600 through the light exit surface 800b.

The lenses 500 are used for focusing the light emerging from the light exit surface 800b on the sensor 300.

The light emitting element 100 may be an infrared light-emitting diode, a visible light light-emitting diode, or the like.

The light guiding element 800 comprises a material different from ambient air, that is, the light guiding element 800 has a refractive index different from that of the ambient air. After the light enters the light guiding element 800 through the light incident surface 800a, the light can only be transmitted inside the light guiding element 800 due to the refractive index difference. The light guiding element 800 may be a prism, an optical waveguide, or the like.

The touch space 400 is polygonal, for example, quadrilateral, pentagonal, or hexagonal.

A height h from a surface 601 of the substrate 600 where the sensor 300 is located to a top portion 801 of the corresponding light guiding element 800 is less than a height H from the surface 601 of the substrate 600 where the sensor 300 is located to the upper edge 401 of the touch space 400.

In the optical touch module of the present invention, after the light emitting element 100 emits light to the touch space 400 through the light emitting surface 101, the light passes through the touch space 400, and is incident on the reflector 200 at two side edges opposite to the light emitting element 100 and the light guiding element 800, and then reflected by the reflector 200. Afterward, the light reflected by the reflector 200 is received by the light incident surface 800a of the light guiding element 800, and then transmitted to emerge from the light guiding element 800 through the light exit surface 800b. After the light emerges from the light exit surface 800b, the lens 500 adjacent to the light exit surface 800b focuses the light on the sensor 300. Finally, the sensor 300 receives the light.

When a finger or another object contacts the touch space 400, a portion of the light reflected by the reflector 200 to the touch space 400 is intercepted. At this time, when the sensor 300 receives the light from the touch space 400 through the light guiding element 800 and the lenses 500, the sensor 300 can determine a relative position of the finger or the other object on the touch space 400 according to the portion of the light intercepted.

Herein, the sensor 300 is fabricated on the substrate 600, and the light from the touch space 400 is transmitted to the sensor 300 by using the light guiding element 800 and the lenses 500. On one hand, since the substrate 600 may be an ITO glass in the LCD 700, the cost of an additional substrate 600 required for disposing the sensor 300 on a glass panel of the LCD 700 can be saved. On the other hand, since elements such as the sensor 300 and the lenses 500 are disposed below the touch space 400, the thickness of the optical touch screen can be reduced.

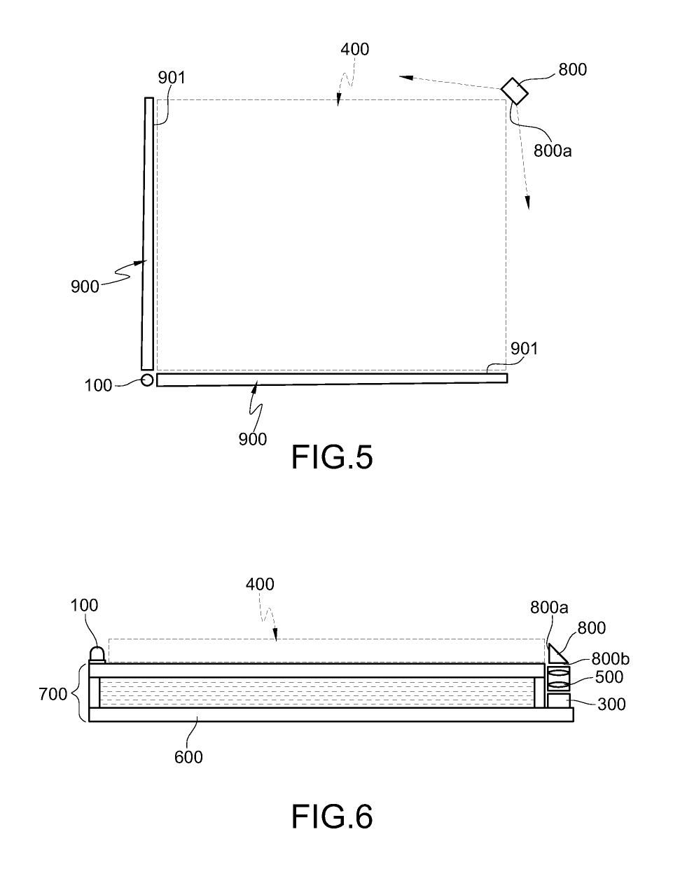

FIG. 5 is a top view of an optical touch module according to a second embodiment of the present invention. FIG. 6 is a side view of the optical touch module according to the second embodiment of the present invention.

Referring to FIGS. 5 and 6 together with the above embodiment, in this embodiment, the optical touch module further comprises at least one waveguide element 900. The number of the waveguide element 900 may be more than one. For the convenience of illustration, in this embodiment, the number of the waveguide element 900 is two, but the present invention is not limited thereto.

The light emitting element 100 is disposed at a diagonal position of the touch space 400 opposite to the light guiding element 800.

The two waveguide elements 900 may be respectively disposed on two side edges of the touch space 400 adjacent to the light emitting element 100. Such a waveguide element 900 may have a tapered structure with one end close to the light emitting element 100 being thicker than the other end far away from the light emitting element 100, and may also have flat-plate structure. Each waveguide element 900 has a light exit surface 901 facing the touch space 400.

Such a waveguide element 900 comprises a material different from ambient air, that is, the waveguide element 900 has a refractive index different from that of the ambient air. Due to the refractive index difference, after the light enters the waveguide element 900, the light can only be transmitted inside the waveguide element 900, and then emerge from the waveguide element 900 through the light exit surface 901.

The two waveguide elements 900 are used for receiving the light emitted by the light emitting element 100, and confining the light inside the waveguide elements 900, such that the light is only transmitted inside the waveguide elements 900 and emerges from the light exit surface 901 to the touch space 400.

In this embodiment, after the light emitting element 100 emits light, the light emitted by the light emitting element 100 is firstly received by the two waveguide elements 900 facing the light emitting element 100. Due to the refractive index difference between the waveguide elements 900 and the ambient air, the light can only be transmitted inside the two waveguide elements 900, until the light emerges from the two waveguide elements 900 through the light exit surface 901 and is then distributed within the touch space 400. Afterward, the light reflected by the reflector 200 is received by the light incident surface 800a of the light guiding element 800, and transmitted to emerge from the light guiding element 800 through the light exit surface 800b. After the light emerges from the light exit surface 800b, the lens 500 adjacent to the light exit surface 800b focuses the light on the sensor 300. Finally, the sensor 300 receives the light.

When a finger or another object contacts the touch space 400, a portion of the light reflected by the reflector 200 to the touch space 400 is intercepted. At this time, when the sensor 300 receives the light from the touch space 400 through the light guiding element 800 and the lenses 500, the sensor 300 can determine a relative position of the finger or the other object on the touch space 400, since the intercepted light cannot be received.

In this embodiment, no reflector needs to be used, and instead, the waveguide elements 900 are used to uniformly distribute the light emitted by the light emitting element 100 onto the touch space 400, thereby improving the resistance of the optical touch module to ambient light, and preventing the light emitted by the light emitting element 100 from being interfered by the light received by the sensor 300. Meanwhile, the brightness of the light emitted by the light emitting element 100 can be lowered, the current loss can be reduced, and the alignment precision of the optical touch module can be improved.

In the optical touch module of the present invention, since the sensor is disposed on the same substrate as the LCD, the cost required for disposing the sensor on an additional substrate can be saved. Moreover, since elements such as the sensor and the lens are disposed below the touch space, the thickness of the optical touch screen can be reduced.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An optical touch module, for providing a touch space, comprising:
a substrate, located below the touch space;
at least one sensor, located on a surface of the substrate facing the touch space; and
at least one light guiding element, located at a corner of the touch space, wherein each light guiding element comprises:
a light incident surface, facing the touch space; and
a light exit surface, facing one of the at least one sensor.

2. The optical touch module according to claim 1, wherein the light guiding element is a prism or an optical waveguide.

3. The optical touch module according to claim 1, further comprising:
at least one lens, each located between the light exit surface of one of the at least one light guiding element and the corresponding sensor.

4. The optical touch module according to claim 1, wherein the substrate is an indium tin oxide (ITO) glass or a printed circuit board (PCB).

5. The optical touch module according to claim 1, further comprising a liquid crystal display (LCD), wherein the substrate is an indium tin oxide (ITO) glass in the LCD.

6. The optical touch module according to claim 1, further comprising a liquid crystal display (LCD), wherein the substrate is a printed circuit board (PCB), and the LCD is directly connected to the PCB.

7. The optical touch module according to claim 1, wherein a height from the surface of the substrate where the sensor is located to a top portion of the light guiding element is less than a height from the surface of the substrate where the sensor is located to an upper edge of the touch space.

8. The optical touch module according to claim 1, further comprising a light emitting surface, located at a corner of the touch space, for providing light substantially in parallel with an upper edge of the touch space.

9. The optical touch module according to claim 8, wherein the at least one light guiding element is correspondingly disposed on the at least one sensor, such that the light incident surface of the light guiding element receives the light and guides the light to the corresponding sensor via the light exit surface.
